(19) United States
(12) Patent Application Publication
(10) Pub. No.: US 2025/0192882 A1
(43) Pub. Date: Jun. 12, 2025

(54) Systems and methods for proactively detecting faulty optical fibers using OTDR data, environmental data, and machine learning

(71) Applicant: EXFO Inc., Quebec (CA)

(72) Inventors: Christopher DAUMER, Rennes (FR); Thierry BOUSSAC, Rennes (FR)

(73) Assignee: EXFO Inc., Quebec (CA)

(21) Appl. No.: 18/969,857

(22) Filed: Dec. 5, 2024

Related U.S. Application Data
(60) Provisional application No. 63/609,178, filed on Dec. 12, 2023.

(51) Int. Cl. H04B 10/071

(52) U.S. Cl. CPC H04B 10/071

(57) ABSTRACT

Systems and methods for detecting faulty optical fibers. A method, according to one implementation, includes collecting data associated with an optical fiber network, wherein the data includes optical fiber performance data, and data associated with one or more environmental factors; performing a first linear regression analysis on the data; performing a second linear regression analysis on results of the first linear regression analysis; and determining one or more issues relating to the optical fiber network based on results of the second linear regression analysis.

### CROSS-REFERENCE TO RELATED APPLICATION(S)

The present disclosure claims priority to U.S. Provisional Patent Application No. 63/609,178, filed Dec. 12, 2023, the contents of which are incorporated by reference in their entirety.

### FIELD OF THE DISCLOSURE

The present disclosure generally relates to optic fiber testing systems and methods. More particularly, the present disclosure relates to systems and methods for proactively detecting faulty optical fibers using Optical Time-Domain Reflectometry (OTDR) data, environmental data, and machine learning.

### BACKGROUND OF THE DISCLOSURE

Optical Time-Domain Reflectometry (OTDR) is a technique for testing optical fibers by injecting a series of pulses into a fiber under test and measuring scattered and/or reflected light at the same end. The backscattered and/or reflected light is used to characterize the fiber under test. Also, there is a desire to proactively detect problems in optical fiber systems, and in particular splices, connectors by detecting sensitivities between physical/optical events on the fiber route, such as fiber and junction loss, reflectance, fiber loss, etc. and environmental parameters such as ambient temperature, humidity, atmospheric pressure, air/water salinity, wind speed and direction, visibility, precipitation, lightning frequency and distance, dew point, etc. Of course, an OTDR can provide a snapshot in time of the performance of the actual fiber, and measurements over time can show trends in the performance of the actual fiber. However, this data is limited and it is difficult to proactively identify fiber degradation and act on potential failures before they occur. Because of this, a more sophisticated predictive and proactive approach to optical fiber fault identification and maintenance is needed.

### BRIEF SUMMARY OF THE DISCLOSURE

The present disclosure pertains to a system and method for proactively detecting and predicting faults in optical fibers by utilizing Optical Time Domain Reflectometers (OTDRs), environmental sensors, and machine learning models. The system is designed to monitor, analyze, and interpret relationships between physical or optical events occurring within the optical fibers and various environmental factors, such as temperature, humidity, mechanical stress, or vibration. By continuously tracking and correlating these relationships over time, the system generates trend data that reflects the general degradation tendencies of the fiber optic network. This real-time monitoring and analysis enable the early identification of potential issues, allowing corrective measures to be implemented proactively, thereby preventing catastrophic failures or service disruptions within the optical network.

According to one implementation, systems and methods for detecting faulty optical fibers includes the steps of collecting data associated with an optical fiber network, wherein the data includes optical fiber performance data, and data associated with one or more environmental factors; performing a first linear regression analysis on the data; performing a second linear regression analysis on results of the first linear regression analysis; and determining one or more issues relating to the optical fiber network based on results of the second linear regression analysis.

The steps can further include wherein a plurality of first linear regression analysis and second linear regression analysis are performed over a period of time. The collecting data can be performed continuously, or at predetermined intervals based on a received configuration. The optical fiber performance data can include optical power loss. The optical fiber performance data can be collected via one or more Optical Time-Domain Reflectometry (OTDR) devices. The first linear regression analysis can include using the optical power loss as a dependent variable, and using the data associated with the one or more environmental factors an independent variable. The second linear regression analysis can include using intercept values of the first linear regression analysis as a dependent variable, and using time as an independent variable. The data associated with environmental factors can include any of ambient temperature, humidity, atmospheric pressure, air/water salinity, wind speed and direction, visibility, precipitation, lightning frequency and distance, and dew point at one or more locations associated with the optical fiber network. The one or more locations associated with the optical fiber network can include one or more locations having any of junctions, splices, connectors, and bends in optical fibers. The steps can further include providing one or more visual representations of the data and the results of the first and second linear regression analyses via a Graphical User Interface (GUI).

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a diagram illustrating a fiber testing arrangement with an Optical Time-Domain Reflectometry (OTDR) device.

FIG. 2 is a block diagram illustrating a test device including the Optical Time-Domain Reflectometry (OTDR) device shown in FIG. 1, an environmental sensor, and an analysis module, according to various embodiments.

FIG. 3 is an example regression plane demonstrating the performance loss of an optical fiber correlated to environmental factors at a point along an optical fiber.

FIG. 4 is an example of a GUI for displaying optical fiber network metrics and correlation data.

FIG. 5 is a flow diagram illustrating an embodiment of a process for detecting faulty optical fibers.

### DETAILED DESCRIPTION OF THE DISCLOSURE

The present disclosure provides systems and methods for proactively detecting faults in point to point and point to multipoint fiber optic systems using OTDRs, environmental sensors and Machine Learning (ML) models. Various embodiments utilize processes to detect potential problems within optical fiber networks by analyzing environmental factors such as weather, and optical performance data. Thus far, analytical approaches for detecting fiber optic network faults have relied on manual processing and standard data visualization tools which often struggle with large and complex datasets. Thus, these approaches are not suitable for large-scale optical fiber networks or for proactively detecting problems. Alternatively, the present advanced analytics approach improves the analysis process. The systems and methods described herein provide the ability to pinpoint faulty fibers with high precision. By continuously monitoring key physical characteristics of the fiber and analyzing data, network operators are able to proactively identify and address potential issues in the optical fiber infrastructure.

OTDR is a diagnostic technique for optical fiber links where a test signal in the form of light pulses is launched in the optical fiber link under test and the return light signal, arising from backscattering and reflections along the link, is detected. The acquired power level of the return light signal as a function of time is referred to as an “OTDR trace” or a “reflectometric trace”, where the time scale is representative of distance between the OTDR acquisition device and a point along the fiber link. Herein, the process of launching a test signal and acquiring the return light signal to obtain therefrom an OTDR trace is referred to as an “OTDR acquisition”.

“Backscattering” refers to Rayleigh scattering occurring from the interaction of the travelling light with the optical fiber media all along the fiber link, resulting in a generally sloped backscattering level (in logarithmic units, i.e. dB, on the ordinate) on the OTDR trace, whose intensity disappears at the end of the range of the travelling pulse. “Events” along the fiber will generally result in a more localized drop of the backscattered light on the OTDR trace, which is attributable to a localized loss, and/or in a localized reflection peak. It will be understood that an “event” characterized by the OTDR device may be generated by any perturbation along the fiber link which affects the returning light. Typically, an event may be generated by an optical fiber splice along the fiber link, which is characterized by a localized loss with little or no reflection. Mating connectors can also generate events that typically present reflectance, although these may be impossible to detect in some instances. OTDR methods and systems may also provide for the identification of events such as a fiber breakage, characterized by substantial localized loss and, frequently, a concomitant reflection peak, as well as loss resulting from a bend in the fiber. Finally, any other component along the fiber link may also be manifest as an “event” generating localized loss. The generally sloped backscattering level in-between events is indicative of the optical fiber attenuation coefficient of optical fiber segments in-between such events. OTDR methods and systems may therefore also provide a characterization of such optical fiber segments, including its length and fiber loss or fiber attenuation coefficient.

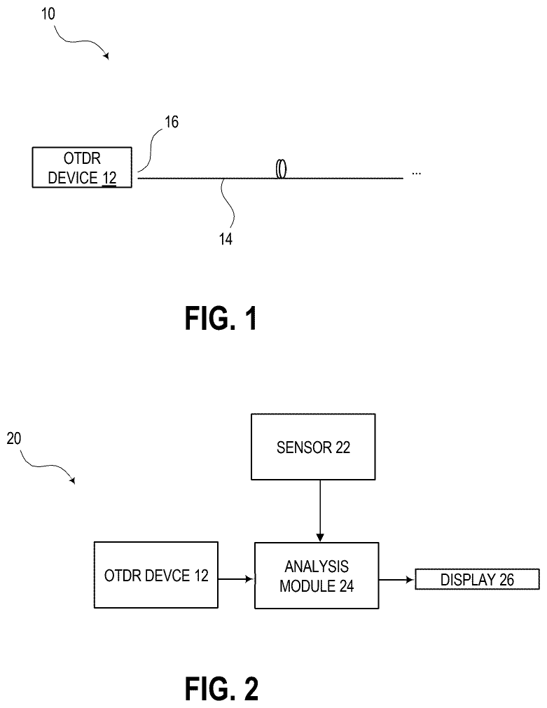

FIG. 1 is a diagram illustrating an example of a fiber testing arrangement 10. In this embodiment, the fiber testing arrangement 10 includes an OTDR device 12 connected directly to an optical fiber 14 under test via a connector 16. The OTDR device 12 performs OTDR acquisition(s) toward the optical fiber 14 to obtain one or more reflectometric traces. The OTDR device 12 can then process the reflectometric trace(s) to determine the condition of the optical fiber 14 under test.

It should be noted that the reflectometric traces are not a simple pulse-like response, but instead include multiple reflections from multiple parts of the optical fiber 14 and any associated optical components. It should also be noted that OTDR uses time-based processing (e.g., similar to radar) for determining a distance (or length) along the optical fiber 14 where certain conditions may be detected. The forward OTDR signals may experience certain discontinuities along the optical fiber 14, such as fiber cuts, fiber bends, crimps, dirty connectors, etc. The forward OTDR signals will be reflected off these discontinuities and sent back toward the source (e.g., the OTDR device 12). The OTDR device 12 can then detect optical power loss or other identifiable characteristics in the reflected signals to identify these discontinuities. Other reflectometry characteristics may be caused by an open connection at the end of the optical fiber 14, another optical component at the end of the optical fiber 14 (e.g., amplifier, attenuator, multiplexer, demultiplexer, etc.), etc., which too can be identified by the OTDR device 12.

FIG. 2 is a block diagram illustrating a test system 20 including the OTDR device 12, an environmental sensor 22, and an analysis module 24, according to various embodiments.

The OTDR device 12 is configured to obtain performance data of the optical fiber 14, including the characterization of events and optical fiber segments along the optical fiber 14. Concurrently, the environmental sensor 22 is configured to obtain one or more environmental parameters such as, for example, ambient temperature, humidity, atmospheric pressure, air/water salinity, wind speed and direction, visibility, precipitation, lightning frequency and distance, dew point, etc.

The environmental sensor 22 can be meteometric environmental sensors and there can be multiple sensors 22 located along the optical fiber 14. For example, the sensors 22 can be placed at the site of known physical/optical events (for example at fusion splices, connectors or macro-bends) or using fiber-as-a-sensor techniques (temperature, strain, vibration, movement), i.e., using the optical fiber 14 itself to derive the environmental parameters.

For analysis, the OTDR device 12 and the environmental sensor 22 provide their outputs to the analysis module 24, which can be a processing device, a cloud service, or the like. The present disclosure provides systems and methods for proactively detecting faults in point to point and point to multipoint fiber optic systems using OTDRs, environmental sensors and Machine Learning (ML) models. Various embodiments utilize processes to detect potential problems within optical fiber networks by analyzing environmental factors such as weather, and optical performance data. Thus far, analytical approaches for detecting fiber optic network faults have relied on manual processing and standard data visualization tools which often struggle with large and complex datasets. Thus, these approaches are not suitable for large-scale optical fiber networks. Alternatively, the present advanced analytics approach improves the analysis process. The systems and methods described herein provide the ability to pinpoint faulty fibers with high precision. By continuously monitoring key physical characteristics of the fiber and analyzing data, network operators are able to proactively identify and address potential issues in the optical fiber infrastructure.

The present disclosure provides advanced techniques for accurately detecting and diagnosing problems in optical fibers by leveraging the interplay between performance data of optical events and/or specific optical fiber segments and a wide array of environmental factors. Performance data includes localized loss, reflectance, overall fiber loss, and other measurable optical parameters. Environmental factors encompass ambient temperature, humidity, atmospheric pressure, air and water salinity, wind speed and direction, visibility, precipitation, lightning frequency and distance, dew point, among others. These environmental factors can significantly influence the performance of optical fibers, especially in adverse conditions or high-stress environments.

To gather this data, the environmental sensors 22 are strategically placed at key points along the optical fibers, such as junctions, splices, connectors, and macro-bends, where vulnerabilities are most likely to arise. Additionally, in certain embodiments, advanced fiber-as-a-sensor techniques are utilized, enabling the optical fiber itself to act as a distributed sensor for capturing data related to temperature, strain, vibration, and movement. By continuously monitoring these parameters, the system 20 identifies trends and correlations over time, producing general tendency data that highlights potential degradation in the fiber optic network's performance before it results in significant service disruption.

Once data is collected, it undergoes a rigorous analytical process. A ranked correlation analysis identifies which loss events (e.g., at splices or connectors) from the OTDR device 12 exhibit strong correlations with specific environmental factors from the environmental sensors 22. For example, a high correlation coefficient (>0.5) between temperature fluctuations and optical loss at a splice point indicates a significant relationship. This correlation data is then input into a linear regression model where the optical loss metric, such as signal power or attenuation, serves as the dependent variable, and the associated environmental factors serve as independent variables.

The regression model calculates an intercept value, representing the baseline signal loss under reference conditions, such as a fixed temperature. By tracking the evolution of this intercept value over time, the system identifies deviations from expected behavior that signify potential degradation. A second linear regression analysis is then performed on these intercept values, using time as the independent variable. The resulting slope from this secondary analysis provides crucial insights into the long-term degradation trends. A slope exceeding a predetermined threshold (e.g., >5) indicates accelerating degradation, flagging the affected fiber segment for further inspection or proactive maintenance.

The ability to correlate environmental factors with optical loss and track changes over time enables the system 20 to autonomously generate a prioritized list of problematic points along the optical fibers, such as splices, bends, or connectors. These locations, identified through loss variability analysis, are localized and flagged for maintenance or replacement. This is particularly effective because an ideal optical fiber route, when functioning correctly, should exhibit minimal sensitivity to environmental changes.

In various embodiments, the system 20 described herein operates continuously to collect and analyze data, providing real-time insights into the status and health of a fiber optic network. The system 20 leverages a combination of data collection methods, such as utilizing OTDRs, to monitor optical events, including signal losses during transmission through optical fibers, optical power attenuation, and related performance metrics. Concurrently, data on environmental factors is collected through strategically positioned environmental sensors 22, which are installed at specific locations along the fiber network, such as splices, connectors, and bends, where environmental influence is most pronounced.

The environmental data collected includes variables such as temperature, humidity, atmospheric pressure, and other local conditions that may impact the fiber's performance. To ensure comprehensive monitoring, the system is capable of capturing this data continuously or at intervals configurable by the system operators. For example, the data collection frequency can be tailored to suit specific operational requirements or environmental variability. Factors such as daily fluctuations in temperature and humidity, as well as their aggregated minimum, maximum, and average values over days, weeks, months, seasons, and even years, can influence this configuration.

This adaptability ensures that the system 20 is sensitive to both short-term anomalies and long-term trends, allowing operators to fine-tune data acquisition based on the network's operational environment. Moreover, the frequency of data collection itself can be treated as a variable within the correlation and analysis techniques employed by the system. By incorporating the data collection frequency as a parameter, the system enhances its ability to establish robust correlations between optical events and environmental factors, enabling more precise identification of degradation patterns and potential issues within the fiber optic network.

For example, during periods of rapid environmental change (e.g., seasonal transitions), a higher data collection frequency can capture transient effects more effectively, while during periods of stability, a lower frequency may suffice. This dynamic adjustment capability allows the system to optimize resource utilization without compromising the accuracy and reliability of its diagnostic and predictive capabilities.

In an embodiment, the system subjects the collected data to linear regression analysis to identify and quantify relationships between optical power loss and various environmental factors. The optical power loss, as detected by the OTDR device 12, serves as the dependent variable, while the environmental factors, such as temperature, humidity, atmospheric pressure, and other measurable conditions, are used as independent variables in the model.

The regression analysis generates a mathematical model that enables the prediction of optical power loss based on changes in the environmental variables. One critical outcome of this analysis is the determination of the intercept, which represents the baseline or reference loss under standardized conditions, such as at a specific temperature or when other environmental factors are stable. This intercept acts as a benchmark, allowing the system to distinguish between expected operational losses and anomalies that may indicate potential fiber degradation or damage.

For example, the intercept can represent the signal loss under a reference temperature (e.g., 25° C.) with no significant environmental disturbances. Over time, the system continuously tracks the intercept value, enabling operators to detect deviations that may signal the onset of performance degradation in the optical fiber.

To enhance the accuracy of the regression analysis, the system 20 can account for non-linear effects or interactions between environmental factors. For instance, it may integrate advanced regression techniques or transformations, such as polynomial regression or interaction terms, to model more complex relationships. By iteratively refining the model based on new data, the system improves its predictive accuracy and reliability.

This approach also allows the system 20 to identify which environmental factors have the most significant impact on optical power loss. For instance, the regression coefficients provide insights into the sensitivity of the optical fiber to specific conditions, such as temperature-induced expansion or contraction, or humidity-driven microbending. These insights inform targeted maintenance strategies, such as reinforcing vulnerable segments or implementing additional protective measures in areas with high environmental variability. By leveraging this detailed regression analysis, the system 20 provides actionable intelligence that enhances the resilience and reliability of the fiber optic network, ensuring it operates efficiently even in challenging conditions.

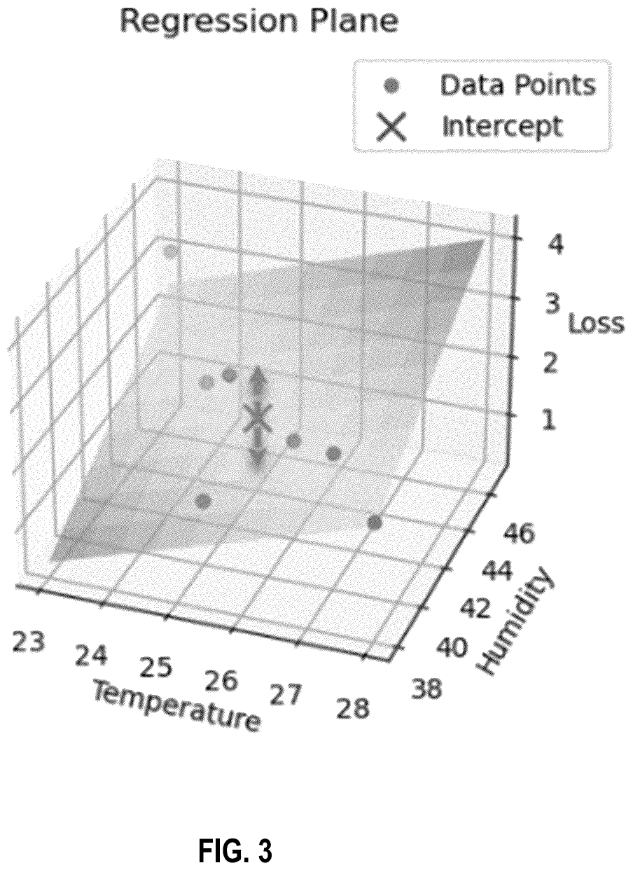

FIG. 3 illustrates an example regression plane that depicts the relationship between optical power loss and environmental factors, specifically temperature and humidity, at a specific point along an optical fiber. The regression plane visually represents how variations in these environmental factors influence the optical power loss, providing a comprehensive view of the fiber's performance under different conditions. Data for constructing the regression plane is collected at critical points of interest along the optical fiber, which can include, but are not limited to, connectors, splices, bends, and other locations susceptible to environmental or mechanical stress.

The intercept of the regression plane represents the baseline optical power loss at a reference state, such as a specific temperature and humidity. This intercept is a key metric, as its value may increase or decrease over time, offering critical insights into the fiber's performance and degradation patterns. By continuously monitoring the evolution of this intercept, the system can detect deviations from expected behavior, serving as an early indicator of potential issues such as microbends, material fatigue, or environmental stressors.

In various embodiments, the system 20 conducts a second layer of analysis to track long-term trends in the intercept values obtained from the initial regression analysis. Specifically, a second linear regression analysis is performed using time as the independent variable and the intercept values as the dependent variable. This secondary analysis evaluates how the intercept evolves over an extended period, with the resulting slope providing valuable insights into the long-term behavior of the optical fiber.

If the slope of this second regression is high (e.g., above a predetermined threshold), it indicates a significant trend, such as accelerated degradation or increasing sensitivity to environmental factors, which warrants immediate attention. The system 20 also correlates these findings with specific environmental factors, identifying those with a correlation coefficient greater than 0.5 as significant contributors to the observed loss patterns. Furthermore, an intercept slope exceeding a predefined value (e.g., slope>5) is flagged as indicative of substantial performance degradation.

To enhance the robustness of these analyses, the system 20 may perform a plurality of first and second regression analyses across various points of interest along the optical fiber network and over extended time periods. This approach allows for the visualization of network-wide trends, enabling operators to pinpoint problematic regions and prioritize maintenance or upgrades accordingly. For example, consistent increases in intercept slopes at splices located in high-temperature regions may indicate the need for improved thermal management or reinforcement.

The combination of initial and longitudinal regression analyses provides a powerful framework for monitoring, diagnosing, and predicting fiber optic network performance. By leveraging these techniques, the system 20 ensures that network operators can proactively address potential issues, minimizing downtime and extending the operational lifespan of the fiber optic infrastructure.

Performing two linear regression analyses is necessary to comprehensively understand both immediate correlations and long-term trends in the data, enabling effective monitoring and management of optical fiber networks. The first regression analysis establishes the relationship between optical power loss (dependent variable) and environmental factors (independent variables such as temperature, humidity, and vibration). This step provides crucial insights into how these factors influence optical performance within a specific time frame. The intercept derived from this analysis represents the baseline optical power loss under reference conditions (e.g., at a specific temperature) and serves as a benchmark for detecting deviations caused by environmental fluctuations. Additionally, this analysis identifies which environmental factors most strongly correlate with power loss, offering immediate diagnostic insights for addressing issues.

However, the first regression alone is insufficient for assessing long-term network health, as it focuses only on short-term variations. The second regression addresses this limitation by using the intercept values from the first analysis as the dependent variable and time as the independent variable. This step tracks how the baseline optical loss evolves over an extended period, providing critical insights into long-term degradation trends. The slope of the second regression model indicates whether the optical fiber is experiencing consistent wear, environmental stress, or improvements due to maintenance. A positive slope, for instance, signifies increasing baseline loss, which could indicate issues such as microbending or material fatigue. This trend analysis enables the system to predict future failures and recommend proactive maintenance measures, minimizing the risk of unexpected disruptions.

Together, these two regression analyses offer a complete picture of the network's performance. The first identifies immediate factors affecting optical loss, while the second examines how the system changes over time, filtering out short-term variability to focus on sustained trends. This dual analysis approach enhances the precision and reliability of the diagnostics, providing actionable intelligence for both real-time problem resolution and long-term strategic planning. Ultimately, it ensures the optical network remains robust and reliable while extending its operational lifespan.

The present systems are designed as a software-based solution capable of ingesting and processing data collected through optical fiber data acquisition techniques, such as those utilizing the OTDR device 12 and the environmental sensors 22. The system 20 can include a non-transitory computer-readable storage medium with computer-readable code stored thereon, which, when executed, enables one or more processors to perform the operations described herein. These operations include data ingestion, analysis, correlation, and predictive diagnostics, all of which are crucial for maintaining the integrity of the fiber optic network. The software solution is designed to run on a wide range of computing platforms, including servers, virtual machines, cloud-based environments, or on-premises hardware. Such adaptability ensures seamless integration into existing network management infrastructures. By automating the described processes, the system minimizes the need for manual intervention, thereby increasing efficiency and reducing the likelihood of human error.

Data from the optical fibers and the environmental sensors 22 is continuously monitored and processed in real-time. The software performs regression analyses and trend analyses on the collected data to identify patterns and correlations that may indicate the early stages of degradation or faults within the optical fiber network. These analyses involve both initial regression models to establish relationships between environmental factors and optical power loss, as well as secondary regression models to track long-term trends over time.

The system 20 is configured to automatically detect and diagnose potential issues within the optical fiber network based on predefined thresholds derived from the regression analyses. For instance, if the slope of a trend line or the correlation coefficient exceeds a specific value, the system flags the affected fiber segment as a potential point of failure. Additionally, the system can be programmed to evaluate multiple thresholds, such as intercept slopes, correlation coefficients, or rate-of-change metrics, to provide a comprehensive assessment of network health.

When a potential issue is identified, the system 20 generates alerts to notify operators. These alerts can include detailed diagnostics, such as the specific location of the problem (e.g., splices, connectors, bends), the environmental factors contributing to the issue, and the severity of the identified trend. The alerts may also recommend corrective actions, such as inspecting a particular segment or implementing protective measures in regions with significant environmental variability.

Moreover, the software solution is scalable, enabling it to accommodate networks of varying sizes and complexities. For larger networks, the system can integrate data from multiple OTDRs and sensor arrays, aggregating information to provide a holistic view of network performance. Advanced visualization tools may also be incorporated to display trends, correlations, and potential problem areas in an intuitive format, aiding operators in decision-making.

By continuously analyzing data and providing actionable insights, the present systems offer a proactive approach to fiber optic network management. This reduces the risk of unexpected failures, minimizes downtime, and extends the operational lifespan of the network, ensuring reliable performance even under dynamic environmental conditions.

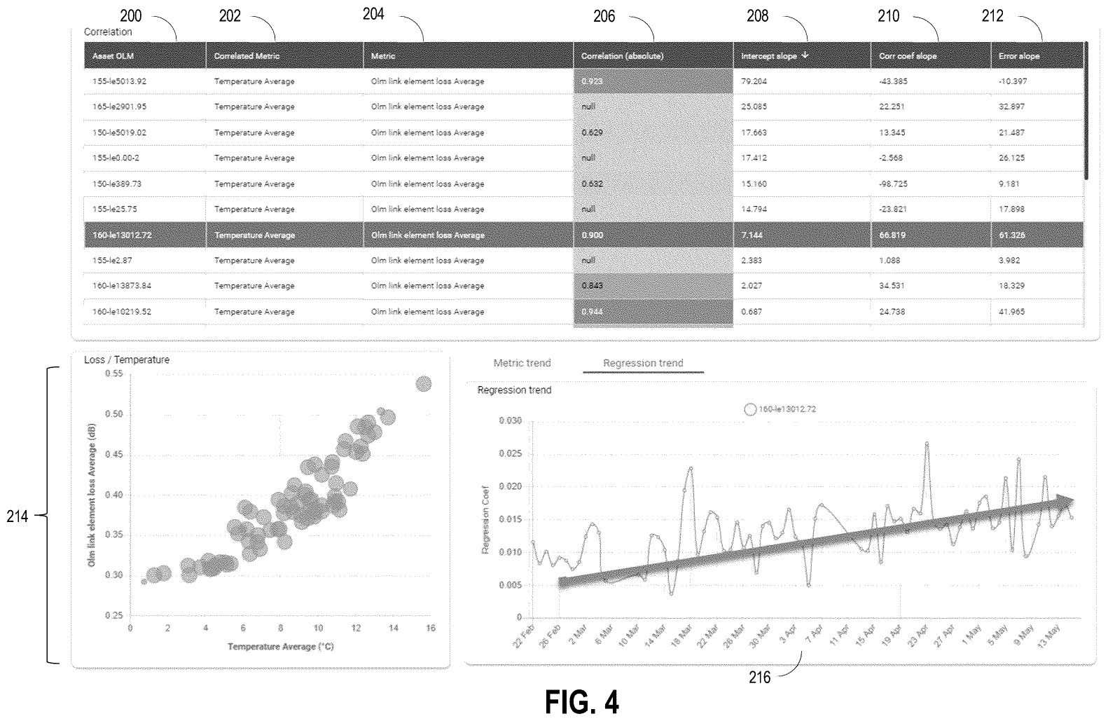

In various embodiments, the outputs of the present systems and methods are displayed in a Graphical User Interface (GUI), allowing for easy interpretation by system operators. FIG. 4 is an example of a GUI for displaying optical fiber network metrics and correlation data. The data displayed in the GUI can be live data which is actively being processed by the present systems. That is, the data shown can be live data ingested by the systems, and various visual representations within the GUI can display live correlation data to system operators.

Further, the GUI can be adapted to display the data in rows, wherein each row provides data associated with a specific point along an optical fiber. The provided data can include, but is not limited to, an identification tag 200 of a point along an optical fiber, one or more environmental factor data points 202, optical fiber performance data 204 (i.e., optical power loss average), correlation coefficient 206, intercept slope 208, correlation coefficient slope 210, and error slope 212. Further, the GUI can allow users to select a row to expand the data for the point along the optical fiber. This is shown in the visual representations 214, the various visual representations 214 showing trends between optical fiber performance data 204 and one or more environmental factors. In the given example, the evolution of the intercept of the regression loss/temperature for the point “OLM 160-le13012.72” shows a significant increase over time. This trend means that the loss is more and more impacted by the temperature for this point along the optical fiber. In this example, the point of interest is an Optical Link Module (OLM) associated with the optical fiber network.

In various embodiments, the main outputs are the correlation coefficient 206 and the intercept slope 208. This correlation is confirmed by the digital visual representations 214. The intercept slope 208 gives the evolution of the intercept over time. This evolution is confirmed by a regression trend 216. Further, the GUI can be adapted to emphasize points along the optical fiber having a high correlation coefficient 206 value. This is shown by the darkened correlation coefficient 206 boxes in the rows of the GUI. This allows system operators to pinpoint potentially faulty fibers. Additionally, processing of this correlated data can output an indication of the status of each point along optical fibers and of the global network using thresholds, i.e., alerting to a point along a fiber based on the correlation coefficient 206 being above a threshold value.

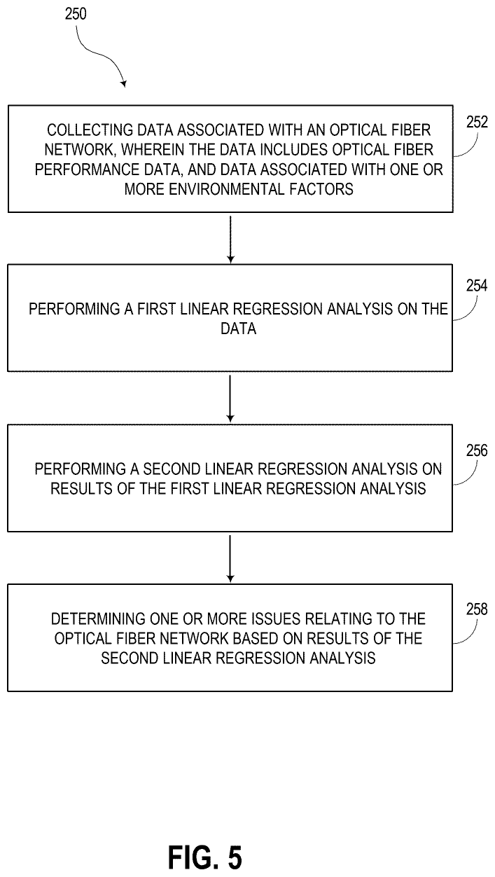

FIG. 5 is a flow diagram illustrating an embodiment of a process 250 for detecting faulty optical fibers. The process 250 includes collecting data associated with an optical fiber network, wherein the data includes optical fiber performance data, and data associated with one or more environmental factors (step 252); performing a first linear regression analysis on the data (step 254); performing a second linear regression analysis on results of the first linear regression analysis (step 256); and determining one or more issues relating to the optical fiber network based on results of the second linear regression analysis (step 258).

The process 250 can further include wherein a plurality of first linear regression analysis and second linear regression analysis are performed over a period of time. The collecting data can be performed continuously, or at predetermined intervals based on a received configuration. The optical fiber performance data can include optical power loss. The optical fiber performance data can be collected via one or more Optical Time-Domain Reflectometry (OTDR) devices. The first linear regression analysis can include using the optical power loss as a dependent variable, and using the data associated with the one or more environmental factors an independent variable. The second linear regression analysis can include using intercept values of the first linear regression analysis as a dependent variable, and using time as an independent variable. The data associated with environmental factors can include any of ambient temperature, humidity, atmospheric pressure, air/water salinity, wind speed and direction, visibility, precipitation, lightning frequency and distance, and dew point at one or more locations associated with the optical fiber network. The one or more locations associated with the optical fiber network can include one or more locations having any of junctions, splices, connectors, and bends in optical fibers. The steps can further include providing one or more visual representations of the data and the results of the first and second linear regression analyses via a Graphical User Interface (GUI).

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A method comprising steps of:
collecting data associated with an optical fiber network, wherein the data includes optical fiber performance data, and data associated with one or more environmental factors;
performing a first linear regression analysis on the data;
performing a second linear regression analysis on results of the first linear regression analysis; and
determining one or more issues relating to the optical fiber network based on results of the second linear regression analysis.

2. The method of claim 1, wherein a plurality of first linear regression analysis and second linear regression analysis are performed over a period of time.

3. The method of claim 1, wherein the collecting data is performed continuously, or at predetermined intervals based on a received configuration.

4. The method of claim 1, wherein the optical fiber performance data includes optical power loss.

5. The method of claim 4, wherein the optical fiber performance data is collected via one or more Optical Time-Domain Reflectometry (OTDR) devices.

6. The method of claim 4, wherein the first linear regression analysis includes using the optical power loss as a dependent variable, and using the data associated with the one or more environmental factors an independent variable.

7. The method of claim 6, wherein the second linear regression analysis includes using intercept values of the first linear regression analysis as a dependent variable, and using time as an independent variable.

8. The method of claim 1, wherein the data associated with environmental factors includes any of ambient temperature, humidity, atmospheric pressure, air/water salinity, wind speed and direction, visibility, precipitation, lightning frequency and distance, and dew point at one or more locations associated with the optical fiber network.

9. The method of claim 8, wherein the one or more locations associated with the optical fiber network include one or more locations having any of junctions, splices, connectors, and bends in optical fibers.

10. The method of claim 1, wherein the steps further comprise:
providing one or more visual representations of the data and the results of the first linear regression analysis and second linear regression analysis via a Graphical User Interface (GUI).

11. A non-transitory computer-readable storage medium having computer-readable code stored thereon for programming at least one processor to perform steps of:
collecting data associated with an optical fiber network, wherein the data includes optical fiber performance data, and data associated with one or more environmental factors;
performing a first linear regression analysis on the data;
performing a second linear regression analysis on results of the first linear regression analysis; and
determining one or more issues relating to the optical fiber network based on results of the second linear regression analysis.

12. The non-transitory computer-readable storage medium of claim 11, wherein a plurality of first linear regression analysis and second linear regression analysis are performed over a period of time.

13. The non-transitory computer-readable storage medium of claim 11, wherein the collecting data is performed continuously, or at predetermined intervals based on a received configuration.

14. The non-transitory computer-readable storage medium of claim 11, wherein the optical fiber performance data includes optical power loss.

15. The non-transitory computer-readable storage medium of claim 14, wherein the optical fiber performance data is collected via one or more Optical Time-Domain Reflectometry (OTDR) devices.

16. The non-transitory computer-readable storage medium of claim 14, wherein the first linear regression analysis includes using the optical power loss as a dependent variable, and using the data associated with the one or more environmental factors as independent variables.

17. The non-transitory computer-readable storage medium of claim 16, wherein the second linear regression analysis includes using intercept values of the first linear regression analysis as dependent variables, and using time as the independent variable.

18. The non-transitory computer-readable storage medium of claim 11, wherein the data associated with environmental factors includes any of ambient temperature, humidity, atmospheric pressure, air/water salinity, wind speed and direction, visibility, precipitation, lightning frequency and distance, and dew point at one or more locations associated with the optical fiber network.

19. The non-transitory computer-readable storage medium of claim 18, wherein the one or more locations associated with the optical fiber network include one or more locations having any of junctions, splices, connectors, and bends in optical fibers.

20. The non-transitory computer-readable storage medium of claim 11, wherein the steps further comprise:
providing one or more visual representations of the data and the results of the first linear regression analysis and second linear regression analysis via a Graphical User Interface (GUI).
